(19) United States
(12) Patent Application Publication
(10) Pub. No.: US 2015/0192183 A1
(43) Pub. Date: Jul. 9, 2015

(54) ENERGY MANAGEMENT SYSTEMS AND METHODS FOR MAKING AND USING THE SAME

(71) Applicant: SABIC Innovative Plastics IP B.V., Bergen op Zoom (NL)

(72) Inventors: Kumar Subramanian Muthu, Bangalore Karnataka (IN); Dinesh Mana, Kundanahalli Bangalore Karnataka (IN)

(73) Assignee: SABIC Innovative Plastics IP B.V., Bergen op Zoom (NL)

(21) Appl. No.: 14/150,296

(22) Filed: Jan. 8, 2014

(51) Int. Cl. F16F 1/46

(52) U.S. Cl. CPC F16F 1/46

(57) ABSTRACT

An energy absorbing element comprises: stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element.

### TECHNICAL FIELD

Disclosed herein are energy management systems, specifically compliant energy absorbing systems that use tensile and/or elastic deformation to absorb energy during an impact.

### BACKGROUND

Commonly available passive modes of energy absorption can be classified into two broad categories: “crushing” and “compression” or “cushioning” modes. An energy absorber configured for energy absorption in the crushing mode can comprise walls mounted over a relatively rigid surface. Upon an impact, the walls crush and absorb energy. Although the crushing mode can be highly efficient for absorbing a narrow range of energy levels, energy absorption in the crushing mode is not elastic, and as such, the crushed parts must be replaced every time after an impact.

Compression or cushioning energy absorption modes use compressible foam for energy absorption. Foams are typically elastic and can return to their original shape after an impact. However, foams are less efficient in terms of energy absorption. For example, while foams are effective to a sixty or seventy percent compression, beyond that point foams become incompressible (i.e., stack up) such that the impact energy is not fully absorbed. Accordingly, this mode of energy absorption cannot make use of the complete space available for energy absorption. In other words, the level of energy absorbed for a given packaging space is limited.

Accordingly, energy management systems that absorb energy through elastic deformation while at the same time generating negligible stack up are continually desired. It would be a further advantage if such systems can meet the desired impact targets with a reduced mass. It would be a still further advantage if the energy management systems could be readily extruded or injection molded.

### BRIEF DESCRIPTION

Disclosed herein energy absorbing elements, energy management systems, and methods of making and using the same.

In an embodiment an energy absorbing element comprises: stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element.

In another embodiment, an energy management system comprises: a first wall; a second wall substantially parallel to the first wall, and an energy absorbing element disposed between the first wall and the second wall; wherein the energy absorbing element comprises stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element.

In an embodiment a method of absorbing energy comprises: impacting a portion of a vehicle comprising an energy management system comprising an energy absorbing element disposed between a first wall and a second wall, wherein the energy absorbing element comprises stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element; and compressing and elastically deforming the energy absorbing element.

The above described and other features are exemplified by the following figures and detailed description.

### BRIEF DESCRIPTION OF THE DRAWINGS

Refer now to the drawings, which are exemplary, not limiting, and wherein like elements are numbered alike.

FIG. 1 illustrates an example of a geometry change of a stiff member.

FIG. 2 is a top view of a four bar mechanism comprising stiff members and a central member.

FIG. 3 is a top view of a single material energy absorbing element.

FIG. 4 is an isometric view of an embodiment of a multi-material energy absorbing element.

FIG. 5 is an isometric view of another multi-material energy absorbing element.

FIG. 6 is an isometric view of an energy management system.

FIGS. 7 to 10 are side views of an energy management system before, during, and after an impact.

FIG. 11 is a graphical illustration of the intrusion versus a remaining amount of energy to be absorbed after impact for the energy management systems disclosed herein compared to a foam system.

FIG. 12 is a graphical illustration of the intrusion versus force for the energy management systems disclosed herein compared to a foam system.

FIGS. 13 to 16 are side views of a foam system before, during, and after an impact.

### DETAILED DESCRIPTION

Disclosed herein, in various embodiments, are energy management systems comprising energy absorbing elements, wherein the energy absorbing elements can comprise a four bar mechanism wherein two opposing joints of the four bar mechanism can be connected to one another to provide efficient energy absorption during an impact. A four bar mechanism with rigid links and frictionless revolute joints generally absorbs a negligible amount of energy during an impact as it offers “zero” stiffness. It was unexpectedly discovered that an efficient energy absorbing element can be obtained by connecting two opposing joints of the four bar mechanism (“central member”). In particular, when a central member has a lower tensile strength as compared to the rigid links, the central member can extend axially and elastically to absorb impact energy. Further, when the joints between the rigid links are flexible, the rigid links can collapse when exposed to an impact and generate negligible stack up. Meanwhile, the energy absorbing element can be economically manufactured using injection molding or extrusion. The energy absorbing element can also be tuned to meet a wide range of energy absorption requirements either by utilizing a single material or a multi-material system or through the connecting member geometrical variations.

Accordingly, an energy absorbing element as described herein can comprise a frame comprising four stiff members and two pairs of opposing hinges configured to connect the four stiff members; and a central member connecting a first pair of the opposing hinges along a longitudinal direction, wherein the four stiff members have a greater tensile strength than the central member. When an impact normal to the central member is applied to the energy absorbing element, the frame can collapse and the central member can elastically extend along the longitudinal direction (e.g., generally parallel to the central member), thus absorbing energy and providing an efficient energy absorbing element.

Exemplary stiff members include bars, walls, rods, and the like. Each stiff member can have a first end (e.g., an edge) and an opposing second end (e.g., an edge), wherein an end of a stiff member can be hingedly coupled to another end of an adjacent stiff member, thus forming a frame. The opposing stiff members can be substantially parallel to each other. The four stiff members can also be positioned such that when connected, they are symmetrical about the impact direction thereby allowing a smooth transfer of the impact energy to the central member. The shape of the frame can be any shape that will provide the desired impact properties to the energy absorbing element. For example, the frame or a cross-section of the frame can have a substantially parallelogram shape, for example a shape of rectangle, square, rhombus, or the like.

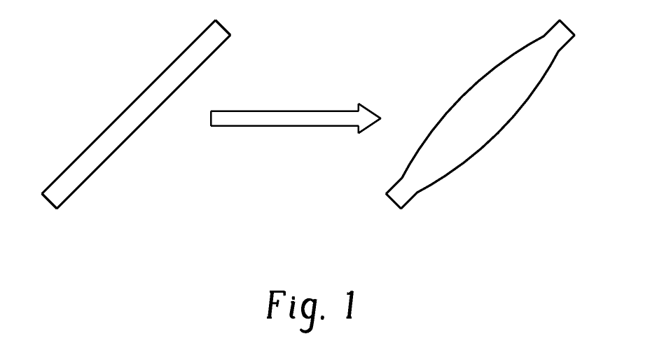

The stiffness of the frame can be tuned by choosing an appropriate material composition of the frame, by adjusting the thickness of the stiff members, or by adjusting the geometry of the stiff members. For example, the thickness of the stiff members can be 1 millimeter (mm) to 20 mm, specifically 2 mm to 15 mm, more specifically 3 mm to 10 mm, and even more specifically, 5 mm to 7 mm. Generally, the stiffness of the frame and the thickness of the stiff members share a proportional relationship such that when the thickness of the stiff members is increased, the stiffness of the frame also increases. The stiffness of a stiff member can generally be increased by a change in geometry, for example, when a stiff member's geometry is changed from a rectangular prism to an ellipsoid (see FIG. 1).

The hinges can include mechanical fastening means to attach the various frame elements together. The hinges can comprise polymeric materials to allow for unitary construction of the energy absorbing element (e.g., so that the energy absorbing element can be formed as a single, solitary piece by various forming methods, including but not limited to, injection molding or extrusion). The hinges can comprise the same or different material than that used for the stiff members. When the materials used to form the hinges and the stiff members are the same, the hinges and the stiff members can be tuned by adjusting the thickness of the stiff members and the hinges so that the hinges have a higher flexibility (i.e., have a lower tensile strength) than the stiff members. When the materials used to form the hinges and the stiff members are different, the material used for the hinges can have a higher modulus than the material used for the stiff members. Optionally, the hinges can be part of the central member. For example, two adjacent stiff members of the frame can both be coupled to the same end of the central member, and the opposing hinges, stiff members, and central member can form an integral part thereof.

The central member can connect one pair of opposing hinges along a longitudinal direction and can have various geometries. Exemplary geometries include bars, rods, flat surfaces, zigzag shapes, sinusoidal, and combinations comprising at least one of the foregoing. The shape of the central member is not particularly limited as long as it is configured to extend along the longitudinal direction when exposed to a perpendicular impact.

The central member can comprise the same or different material as the stiff members. When the central member and the stiff members comprise the same material, the central member can be tuned (e.g., by adjusting the thickness) so that it has a lower tensile strength than the stiff members. For example, the stiff members can be thicker than the central member, for example, greater than or equal to 10% thicker, specifically, greater than or equal to 15% thicker, more specifically, greater than or equal to 20% thicker, even more specifically, greater than or equal to 30% thicker, still more specifically, greater than or equal to 40% thicker, yet more specifically, greater than or equal to 50% thicker, and even more specifically still, greater than or equal to 60% thicker to allow the central member to flex (i.e., absorb energy) upon an impact. Further, when the central member and the stiff members comprise different materials, the material for the stiff members can be chosen such that it has a higher modulus as compared to the material chosen for the central member. For example, a ratio of the modulus of the central member to stiff members can be 0.05 to 1.0, specifically, 0.01 to 0.5, and more specifically, 0.1 to 0.4, if different materials are used. Hinges can be composed of the same material as the central member.

The energy absorbing element comprising a frame comprising stiff members, a central member, and hinges connecting adjacent stiff members can comprise any polymeric material or combination of polymeric materials as long as the material can be formed into the desired shape and provide the desired properties. Exemplary materials include polymeric materials as well as combinations of polymeric materials with elastomeric materials, and/or thermoset materials. Possible polymeric materials include polybutylene terephthalate (PBT); acrylonitrile-butadiene-styrene (ABS); polycarbonate (LEXAN™ and LEXAN™ EXL resins, commercially available from SABIC's Innovative Plastics business); polyethylene terephthalate (PET); polycarbonate/PBT blends; polycarbonate/ABS blends; copolycarbonate-polyesters; acrylic-styrene-acrylonitrile (ASA); acrylonitrile-(ethylene-polypropylene diamine modified)-styrene (AES); phenylene ether resins; blends of polyphenylene ether/polyamide (NORYL GTX™ resins, commercially available from SABIC's Innovative Plastics business); blends of polycarbonate/PET/PBT; PBT and impact modifier (XENOY™ resins, commercially available from SABIC's Innovative Plastics business); polyamides; phenylene sulfide resins; polyvinyl chloride PVC; high impact polystyrene (HIPS); low/high density polyethylene (L/HDPE); polypropylene (PP); expanded polypropylene (EPP); polyethylene and fiber composites; polypropylene and fiber composites (AZDEL Superlite™ sheets, commercially available from Azdel, Inc.); long fiber reinforced thermoplastics (VERTON™ resins, commercially available from SABIC's Innovative Plastics business) and thermoplastic olefins (TPO), as well as a composition comprising at least one of the foregoing.

An exemplary filled resin is STAMAX™ resin, which is a long glass fiber filled polypropylene resin also commercially available from SABIC's Innovative Plastics business. Some possible reinforcing materials include fibers, such as glass, carbon, and so forth, as well as combinations comprising at least one of the foregoing; e.g., long glass fibers and/or long carbon fiber reinforced resins. The energy absorbing elements can also be formed from combinations comprising at least one of any of the above-described materials. For example, in some embodiments, the same material can be used to make each element of the energy management system (e.g. the stiff members, and/or central member, and/or hinges). In other embodiments, different materials can be used to make the various elements of the energy management system (e.g., one material can be used to make the stiff members and central bar and a different material can be used to make the hinges). It is contemplated that any combination of materials can be used to, e.g., enhance crush characteristics, reduce damageability, etc.

Exemplary materials that can be utilized in the formation of the stiff members include, but are not limited to, polycarbonate, polyester (e.g., PBT, PET, and others), as well as combinations comprising at least one of the foregoing materials. For example, the material can comprise XENOY™ resin(s) which is commercially available from SABIC's Innovative Plastics business. In some embodiments, the material can be a polymeric material that is flexible at temperatures of −60° C. to 200° C. For example, unfilled polymeric materials can have a tensile strength of 0.5 gigaPascals (GPa) to 2.8 GPa, a yield of 5 megaPascals (MPa) to 70 MPa, and/or an elongation of 10% to 150%; and filled polymeric materials can have a tensile strength of 1.5 GPa to 10 GPa, and/or an elongation of 0.5% to 10%; while composite materials (e.g., laminates) can have a tensile strength of 80 GPa to 160 GPa, and/or a shear modulus of 70 MPa to 100 MPa. For example, blends of polycarbonate/polybutylene terephthalate (e.g., XENOY™ resin, commercially available from SABIC's Innovative Plastics business) can be employed, having a tensile strength of 1.87 GPa, a yield of 48 MPa, and an elongation of 120%.

Materials for the central members and hinges are not particularly limited. For example, an elastomeric material, specifically, rubber, can be used, or any material as described herein. As used herein, an elastomeric material generally refers to a material that regains its shape and material properties once a load acting upon it has been released. The elastomeric materials can be in the form of homopolymers or copolymers, including random, block, radial block, graft, and core-shell copolymers. For example, the elastomeric material can have a Tg less than 10° C., more specifically less than −10° C., or more specifically −40° to −80° C. Exemplary elastomeric materials can include, but are not limited to, conjugated diene rubbers, for example polybutadiene and polyisoprene; copolymers of a conjugated diene with less than 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers.

The energy absorbing elements can be incorporated directly into vehicle components. In some embodiments, an energy management system is provided, which in turn, can be incorporated into vehicle components. The energy management systems can comprise a first wall, a second wall substantially parallel to the first wall, and an energy absorbing element disposed between the first wall and the second wall. When more than one energy absorbing element is present, the energy absorbing elements can be spaced apart such that when an impact is applied against the system, one element does not get into the way of the adjacent elements.

In the energy management system, the central member of the energy absorbing element can be substantially parallel to the first and the second walls. It is contemplated that more than one row of energy absorbing elements can be disposed between the first and the second walls of the energy management system. In some embodiments, the energy absorbing element can be coupled to the first and second walls of the energy management system through a second pair of opposing hinges.

The first and second walls can comprise a polymeric material as previously described herein, for example, those materials as described for the stiff members. Exemplary materials include polybutylene terephthalate; polyethylene terephthalate; polycarbonate; or a combination comprising at least one of the foregoing.

The overall size, e.g., the specific dimensions of the energy management system will depend upon its location in the vehicle and its function, as well as the particular vehicle for which it is intended. For example, the length (l), height (h), and width (w) of the energy management system, will depend upon the amount of space available in the desired location of use as well as the needed energy absorption. The depth and wall thickness of the various components of the energy management system will also depend upon the available space, desired stiffness, and the materials (or combination of materials) employed. The depth “d” of the energy management system is generally bounded by the distance between the fascia and the bumper beam.

The energy management system or energy absorbing element disclosed herein can be manufactured utilizing various molding processes (e.g., injection molding, thermoforming, extrusion, etc.) to provide a single piece assembly (e.g., an integrally formed frame comprising stiff members, central member, and hinges). For example, the energy management system comprising energy absorbing elements as described herein can be formed by a process selected from injection molding, thermoforming, extrusion, or combinations comprising at least one of the foregoing.

Although the energy management systems comprising energy absorbing elements disclosed herein can be used in any location in a vehicle, they are generally intended for use at the front portion of a vehicle, in front of the bumper beam (e.g., in the portion of the vehicle where the engine, radiator, etc. are generally located) to protect the components located within the body in white (BIW) from damage upon impact. Bumper beams are provided generally to reduce and/or eliminate the damage to vehicle components located behind the bumper beam such as the engine components and radiator. Generally, the energy management systems described herein can be located in the front bumper and/or rear bumper of a vehicle and can be attached to a bumper beam (e.g., metal, thermoplastic, etc.) that is attached to the BIW to serve as protection to the vehicle during an impact. For example, the energy management system can be attached to a bumper beam which is attached to the vehicle rails and/or cross members. Decorative fascia can be disposed over the energy management system.

For high energy levels of low speed impacts, energy management systems attempt to reduce vehicle damage by absorbing impact energy and thus, intrusion into and damage of vehicle components while not exceeding a rail load limit of the vehicle (e.g., the point at which the BIW will begin to deform). In addition, some energy management systems attempt to reduce pedestrian injury as a result of an impact during low energy levels of a low speed impact. The energy management systems described herein comprising a frame comprising stiff elements and hinges connecting the stiff elements can meet the lower leg impact Phase II target requirements (e.g., low energy level) and the vehicle damageability 5 mph requirements set forth by the Federal Motor Vehicle Safety Standards (FMVSS) (e.g., high energy level).

The energy management systems disclosed herein can be designed to absorb energy and deform during impact with a pedestrian and can also be designed to plastically deform and absorb energy during impact with a vehicle, for example, at speeds less than or equal to 16 kilometers per hour (kph) (9 miles per hour (mph)), specifically, less than or equal to 8 kph (5 mph) and can also absorb energy of less than or equal to 2000 Joules (J). Generally, the bumper beam to which the energy management system is attached can provide support to the energy management system and can also serve as a stiff member that elastically deforms and absorbs energy during impacts (e.g., pendulum and barrier impacts).

The energy management systems described herein can meet and/or exceed requirements set forth for low speed crashes, e.g., 49 C.F.R. 581 and the Insurance Institute for Highway Safety (IIHS) for damageability mitigation in a 10 kph collision as well as meeting and/or exceeding pedestrian impact regulatory requirements set forth by various regulatory agencies including, e.g., European Enhanced Vehicle-safety Committee (EEVC), Association des Constructeurs européens d′Automobiles (ACEA, Phase II), and Global Technical Regulations (GTR).

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

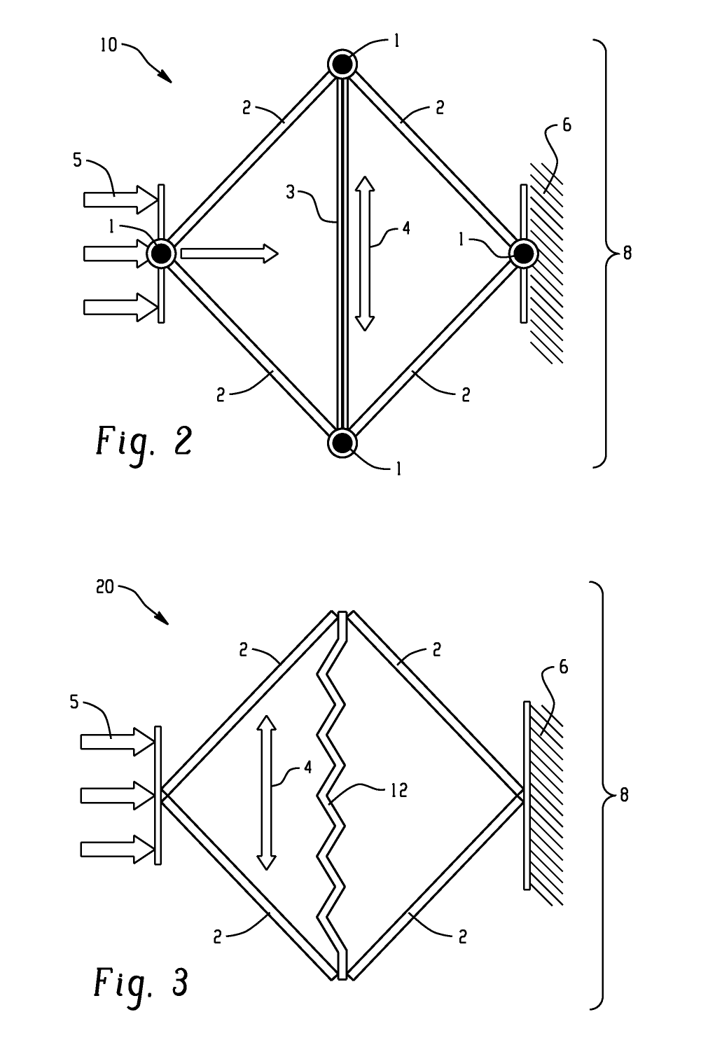

Turning now to FIGS. 2 to 6, different possibilities for the energy management systems disclosed herein are illustrated, wherein various components of the energy management systems are elastically deformable. For example, FIG. 2 illustrates an energy absorbing element 10 comprising stiff members 2 connected by opposing hinges 1 and a central member 3 forming frame 8. The energy absorbing element 10 can be oriented in such a way that impact 5 (i.e., force) is normal to the central member 3. The energy absorbing element 10 can be attached at a fixed location 6 on a side opposite the side receiving the force as seen in FIG. 2. The central member 3 can comprise an elastomeric material such as a rubber, allowing it to be flexible so that it can absorb energy when an impact 5 is applied to the energy absorbing element 10. For example, when an impact 5 is applied to the energy absorbing element 10, the frame 8 can collapse such that the central member 3 begins to extend along a longitudinal direction until the load is released and the energy absorbing element 10 returns to its original shape. As previously described herein, the stiff members 2 and the central member 3 can be formed from the same material or different materials. In FIG. 2, it is contemplated that the stiff members 2 and the central member 3 are formed of different materials, where the central member 3 is formed of a material that will allow the energy absorbing element 10 to flex when an impact 5 is applied.

FIG. 3 illustrates a single material energy absorbing element 20 where the central member 12 has a different geometry than that shown in FIG. 2, here, a zigzag shape. The shape of the central member 12 allows it to absorb energy upon an impact 5. It is contemplated that the central member 12 in energy absorbing element 20 can also have the shape of central member 3 in FIG. 2. When using a single material construction and utilizing the central member 3 of FIG. 2, the stiff members 2 can be thicker than the central member 3, for example, greater than or equal to 10% thicker, specifically, greater than or equal to 15% thicker, more specifically, greater than or equal to 20% thicker, even more specifically, greater than or equal to 30% thicker, yet more specifically, greater than or equal to 40% thicker, even more specifically, greater than or equal to 50% thicker, yet more specifically, greater than or equal to 60% thicker, still more specifically, greater than or equal to 70% thicker, yet more specifically still, greater than or equal to 80%, and yet even more specifically, greater than or equal to 90% thicker, to allow the central member 3 to flex (i.e., absorb energy) upon an impact.

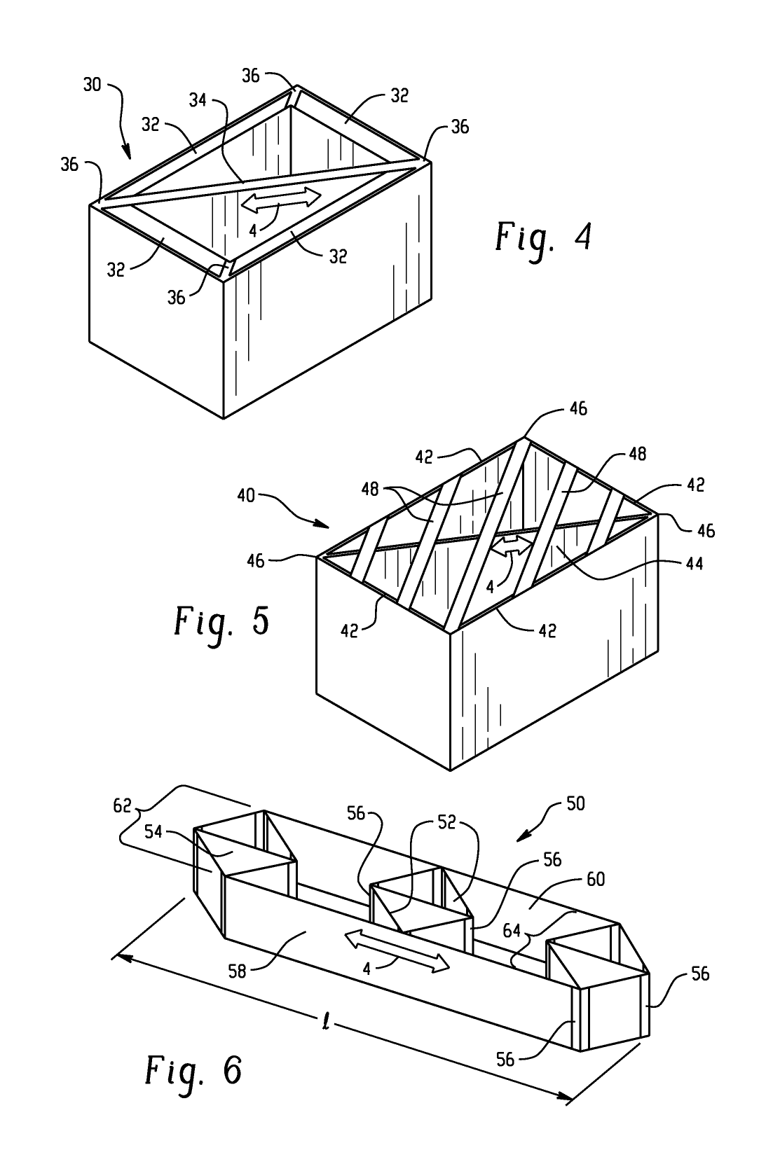

Turning now to FIGS. 4 and 5, various multi-material energy absorbing elements 30, 40 are illustrated. In FIG. 4, an energy absorbing element 30 can comprise stiff members 32 wherein adjacent stiff members 32 are connected by hinges 36 and a central member 34 is dispersed between stiff members 32 and connected to hinges 36. Over molding and/or extrusion can be used to manufacture these energy absorbing elements 30. For example, a thin layer of material used for the central member 34 can be molded over the four stiff members 32 where the hinges 36 comprise the same material as the central member 34. Such a design can help ensure that the hinges are flexible enough to move when an impact occurs and also help ensure adhesion between the stiff member 32 and the central member 34. Exemplary ratios of the thickness of the thin layer of material used for the central member 34 to the thickness of the stiff members can be 0.05 to 0.9, specifically 0.1 to 0.8, more specifically 0.25 to 0.75, and even more specifically, 0.3 to 0.5.

In FIG. 5, another energy absorbing element 40 is illustrated. Here, an energy absorbing element 40 can comprise stiff members 42 wherein adjacent stiff members 42 can be connected by hinges 46 and a central member 44 can be dispersed between adjacent stiff members 42. Connecting members 48 can be disposed between stiff members 42 in a direction perpendicular or nearly perpendicular to the central member 44. The connecting members 48 can generally be made of the same material as the stiff members 42. The presence of connecting members 48 enables easy manufacturing of the energy absorbing element because, during manufacture, the mold/polymeric material can flow from one stiff member to another stiff member and one energy absorbing unit to another energy absorbing unit through the connecting members.

In FIG. 6, an energy management system 50 is illustrated wherein energy absorbing elements 62 can be dispersed across the length, l, of the energy management system 50. The energy absorbing elements can comprise stiff members 52 wherein adjacent stiff members 52 are connected by hinges 56 and a central member 54 located between the stiff members 52. A first wall 58 and a second wall 60 can connect adjacent energy absorbing elements 62 together to form the energy management system 50. The first wall 58 and the second wall 60 can comprise any material previously described herein. For example, walls 58 and 60 can comprise the same material used for the stiff members.

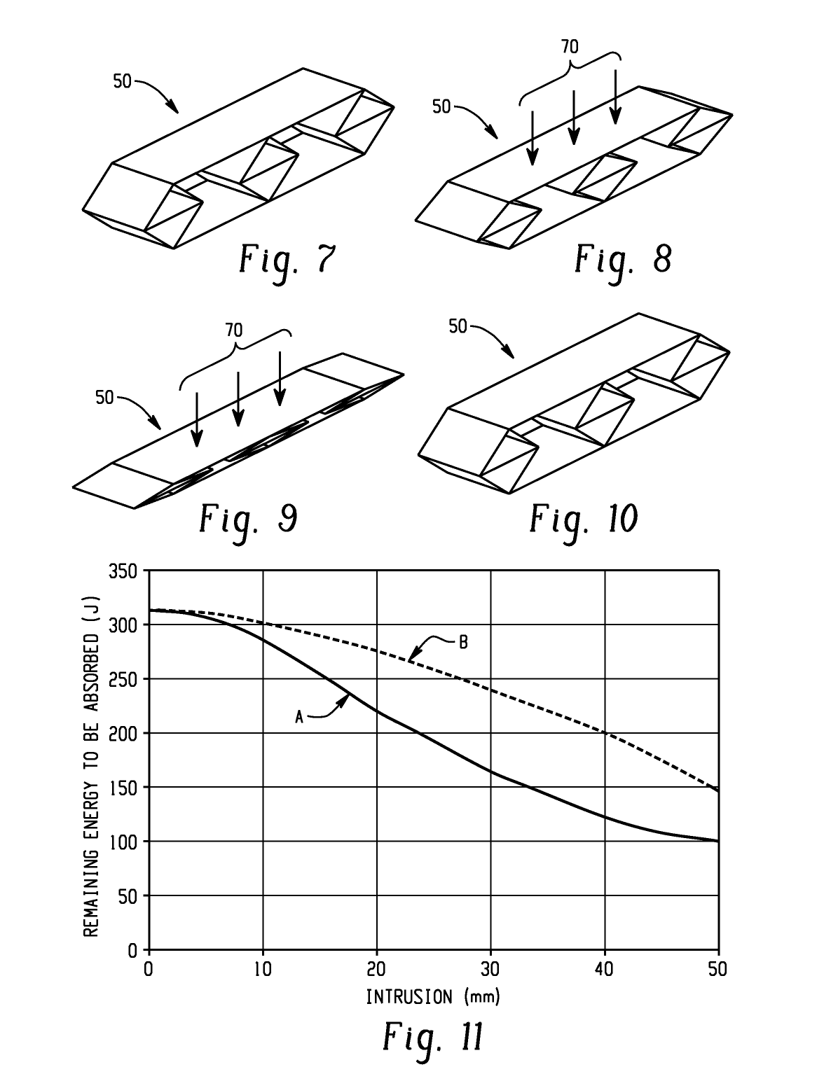

FIGS. 7 through 10 illustrate the energy management system 50 of FIG. 6 in various stages of impact. In FIG. 7, the energy management system 50 is not subject to a force, while in FIG. 8 a force 70 is applied and the energy management system 50 begins to deform, and in FIG. 9 force 70 is continued to be applied. In FIG. 10, the force is removed and the energy management system 50 returns to its original shape.

As described herein, elastically deformable energy absorbing elements can be used in various components within a vehicle system that can benefit from energy absorption. For example, elastically deformable energy absorbing elements can be employed in bumper assemblies, light assemblies (e.g., headlamp assemblies, rearlamp assemblies, interior lighting assemblies, and so forth), dashboard assemblies, hood restraint systems, fender assemblies, roof assemblies, door module assemblies, and/or steering wheel assemblies. The energy absorbing elements can also be used as thermoplastic springs or dampeners which can be attached to a fixed or a moving part to avoid the damage or to control the force levels experienced by either or both of the parts involved in a collision. The elastically deformable elements can provide energy absorption, which, under the desired degree of energy for a particular area, becomes elastic deformation. In the energy management systems disclosed herein, each central member of the energy absorbing elements can be substantially parallel to the first and the second walls. It is contemplated that any number of rows of energy absorbing elements can be employed to provide the desired energy absorption.

The energy absorbing elements and the energy management systems as disclosed herein can be manufactured via any process capable of processing thermoplastic materials. For example, the energy absorbing elements can be thermoformed, extruded, or injection molded.

The energy absorbing elements and energy management systems are further illustrated by the following non-limiting examples. It is noted that all of the examples were simulations unless specifically stated otherwise.

### Examples

### Example 1 and Comparative Example A

The energy management system of Example 1 (hereafter “Compliant System”) is illustrated in FIG. 6. Each energy absorbing element of the energy management system includes four 5 mm thick stiff walls comprising a polymeric material having a modulus of 5 GigaPascals (GPa) (e.g. 30 wt. % glass filled polypropylene) and a 3 mm thick central member comprising an elastomer having a modulus of 0.2 GPa. The properties of the stiff members are representative properties of a 30% glass filled polypropylene. The energy management system of Comparative Example A (hereafter “Foam System”) is illustrated in FIGS. 13 to 16. It comprises a foam having a density of 25 grams per liter (g/l) and has similar dimensions as the Compliant System.

Two sets of simulations are performed to evaluate the feasibility of using the compliant system for impact cases and other applications. The first set simulates an impact scenario and can be seen in FIGS. 7 to 10 as previously described. FIGS. 13 to 16 are isometric views of the foam system. Referring to FIGS. 7 to 10, when no impact is applied to the compliant system, the system has an original shape (FIG. 7). When the compliant system is half loaded, the central member of the energy absorbing element elongates and absorbs energy (FIG. 8). When the compliant system is fully loaded, the upper wall of the energy management system collapses to the lower wall (FIG. 9). When the load (impact) is released, the system recovers its original shape (FIG. 10). In contrast, the foam system generates stack up when it is fully loaded as the foam becomes stiffer and stiffer during the compression and reaches a point wherein the foam cannot be compressed any further (see FIGS. 13 to 16).

In the study, both the Compliant System and the Foam System are simulated to absorb 300 J of energy. The remaining energy to be absorbed (J) versus intrusion (mm) is depicted in FIG. 11, with curve A representing the performance of the compliant system and curve B representing the performance of the foam system. Intrusion generally refers to the extent the compliant system or foam system reaches into the cavity. Ls-dyna, explicit finite element software, is used to simulate the energy absorption capabilities. FIG. 11 demonstrates that the Compliant System absorbs energy more efficiently than the Foam System. For example, for the same intrusion level of 50 mm, the compliant systems absorbs 50 J more energy than the foam system.

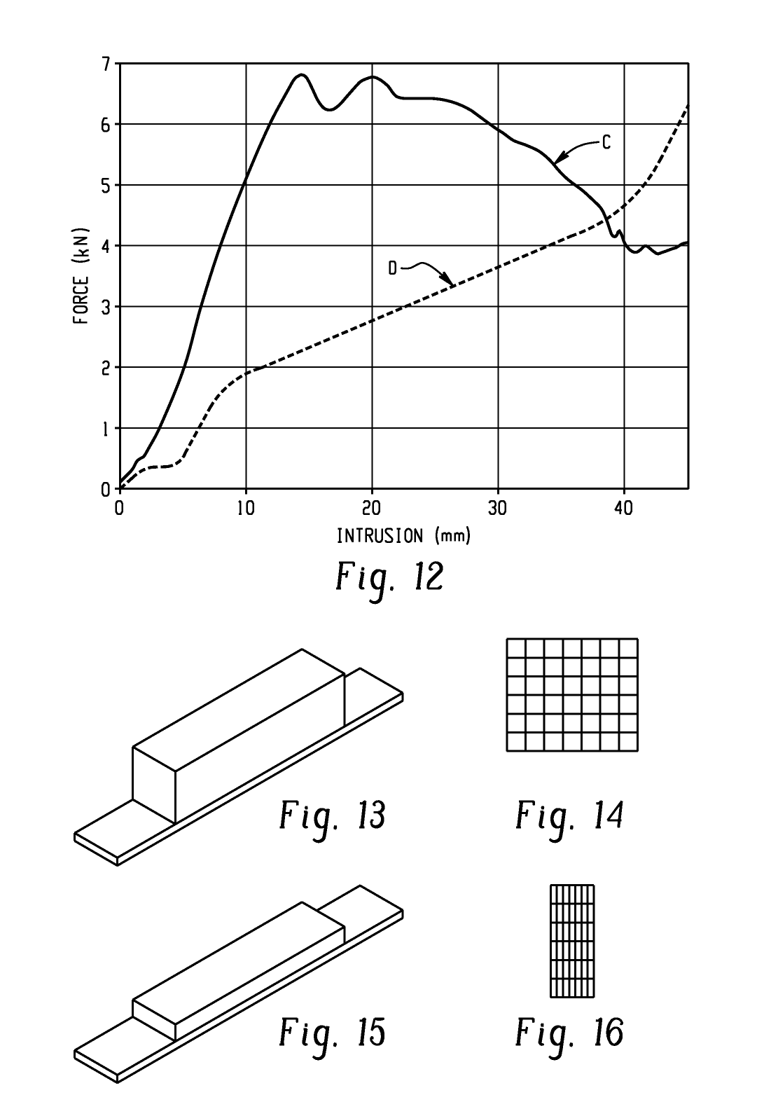

The force, measure in kiloNewtons (kN) versus intrusion (mm) is depicted in FIG. 12 for the complaint system (curve C) and the foam system (curve D). Ls-prepost is used to generate the curves in FIG. 12. The area under the force versus intrusion curve provides the energy absorbed by the system studied. Here, the area of the compliant system is at least two times more than the area for the foam system, which means that the compliant system is greater than or equal to 100% more efficient in absorbing energy than the foam system.

In the second study, the compliant system is loaded with a static load of 5 kN, and the corresponding deformation contour is plotted. It is observed that the maximum deformation experienced by the system is approximately 5 mm, and it is observed that the assembly retains its original shape after releasing the force. Hence, the compliant system is observed to meet both impact and static loading requirements.

The energy management systems disclosed herein enable novel geometric configurations, material, and processing, while being able to achieve elastic deformation with negligible stack up. Further, these systems enable a reduction in system mass and material cost, a reduction in manufacturing cost, and an efficient energy management in minimum space.

The energy management systems and methods of making and using the same disclosed herein include at least the following embodiments:

### Embodiment 1

An energy absorbing element, comprising: stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element.

### Embodiment 2

An energy management system, comprising: a first wall; a second wall substantially parallel to the first wall, and an energy absorbing element disposed between the first wall and the second wall; wherein the energy absorbing element comprises stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element.

### Embodiment 3

A method of absorbing energy, comprising: impacting a portion of a vehicle comprising an energy management system comprising an energy absorbing element disposed between a first wall and a second wall, wherein the energy absorbing element comprises stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element; and compressing and elastically deforming the energy absorbing element.

### Embodiment 4

The energy absorbing element of any of embodiments 1-3, wherein the stiff members collapse along the longitudinal direction when an impact normal to the central member is applied to the energy absorbing element.

### Embodiment 5

The energy absorbing element of any of embodiments 1-4, wherein the stiff members form a frame; and wherein the frame or a cross-section of the frame has a substantially parallelogram geometry.

### Embodiment 6

The energy absorbing element of embodiment 5, wherein the frame or a cross-section of the frame has a geometry selected from rectangle, square, or rhombus.

### Embodiment 7

The energy absorbing element of any of embodiments 1-6, further comprising a connecting member disposed between two adjacent stiff members, wherein the connecting member is disposed nearly perpendicular to the central member.

### Embodiment 8

The energy absorbing element of any of embodiments 1-7, wherein the stiff members have a higher modulus than the central member.

### Embodiment 9

The energy absorbing element of embodiment 8, wherein the stiff members comprise polybutylene terephthalate; polyethylene terephthalate; polycarbonate; or a combination comprising at least one of the foregoing.

### Embodiment 10

The energy absorbing element of embodiment 8, wherein the central member comprises an elastomeric material.

### Embodiment 11

The energy absorbing element of embodiment 10, wherein the hinge comprises the same material as the central member.

### Embodiment 12

The energy absorbing element of any of embodiments 1-11, wherein the stiff members and the central member comprise the same material, and wherein the stiff members are greater than or equal to 40% thicker than the central member.

### Embodiment 13

The energy management system of any of embodiments 2-12, wherein the central member of the energy absorbing element is substantially parallel to the first wall and the second wall.

### Embodiment 14

The energy management system of any of embodiments 2-13, wherein the energy absorbing element is coupled to the first and second walls through a second pair of the opposing hinges.

### Embodiment 15

The energy management system of any of embodiments 2-14, wherein the first and second walls are made of a material comprising polybutylene terephthalate; polyethylene terephthalate; polycarbonate; or a combination comprising at least one of the foregoing.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All ranges disclosed herein are inclusive of the endpoints, and the endpoints are independently combinable with each other (e.g., ranges of “up to 25 wt. % or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films) Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. As used herein, “substantially” generally refers to less than 100%, but generally, greater than or equal to 50%, specifically, greater than or equal to 75%, more specifically, greater than or equal to 80%, and even more specifically, greater than or equal to 90%.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

What is claimed is:

1. An energy absorbing element, comprising:
stiff members, wherein adjacent stiff members are connected by opposing hinges; and
a central member connecting a first pair of the opposing hinges along a longitudinal direction;
wherein the stiff members have a greater tensile strength than the central member; and
wherein the central member is adapted to elastically extend along the longitudinal direction when an impact normal to the central member is applied to the energy absorbing element.

2. The energy absorbing element of claim 1, wherein the stiff members collapse along the longitudinal direction when an impact normal to the central member is applied to the energy absorbing element.

3. The energy absorbing element of claim 1, wherein the stiff members form a frame; and wherein the frame or a cross-section of the frame has a substantially parallelogram geometry.

4. The energy absorbing element of claim 3, wherein the frame or a cross-section of the frame has a geometry selected from rectangle, square, or rhombus.

5. The energy absorbing element of claim 1, further comprising a connecting member disposed between two adjacent stiff members, wherein the connecting member is disposed nearly perpendicular to the central member.

6. The energy absorbing element of claim 1, wherein the stiff members have a higher modulus than the central member.

7. The energy absorbing element of claim 6, wherein the stiff members comprise polybutylene terephthalate; polyethylene terephthalate; polycarbonate; or a combination comprising at least one of the foregoing.

8. The energy absorbing element of claim 6, wherein the central member comprises an elastomeric material.

9. The energy absorbing element of claim 7, wherein the hinge comprises the same material as the central member.

10. The energy absorbing element of claim 1, wherein the stiff members and the central member comprise the same material, and wherein the stiff members are greater than or equal to 40% thicker than the central member.

11. An energy management system, comprising:
a first wall;
a second wall substantially parallel to the first wall; and
an energy absorbing element disposed between the first wall and the second wall;
wherein the energy absorbing element comprises
stiff members, wherein adjacent stiff members are connected by opposing hinges; and
a central member connecting a first pair of the opposing hinges along a longitudinal direction;
wherein the stiff members have a greater tensile strength than the central member; and
wherein the central member is adapted to elastically extend along the longitudinal direction when an impact normal to the central member is applied to the energy absorbing element.

12. The energy management system of claim 11, wherein the central member of the energy absorbing element is substantially parallel to the first wall and the second wall.

13. The energy management system of claim 11, wherein the energy absorbing element is coupled to the first and second walls through a second pair of the opposing hinges.

14. The energy management system of claim 11, wherein the first and second walls are made of a material comprising polybutylene terephthalate; polyethylene terephthalate; polycarbonate; or a combination comprising at least one of the foregoing.

15. The energy management system of claim 11, wherein the stiff members of the energy absorbing element form a frame; and wherein the frame or a cross-section of the frame has a substantially parallelogram geometry.

16. The energy management system of claim 11, wherein the energy absorbing elements further comprises a connecting member disposed between two adjacent stiff members, wherein the connecting member is disposed nearly perpendicular to the central member.

17. A method of absorbing energy, comprising:
impacting a portion of a vehicle comprising an energy management system comprising an energy absorbing element disposed between a first wall and a second wall, wherein the energy absorbing element comprises stiff members, wherein adjacent stiff members are connected by opposing hinges; and a central member connecting a first pair of the opposing hinges along a longitudinal direction; wherein the stiff members have a greater tensile strength than the central member; and wherein the central member is adapted to elastically extend along the longitudinal direction when an impact normal to the central member is applied to the energy absorbing element; and
compressing and elastically deforming the energy absorbing element.

18. The method of claim 17, wherein the central member of the energy absorbing element is substantially parallel to the first wall and the second wall.

19. The method of claim 17, wherein the energy absorbing element is coupled to the first and second walls through a second pair of the opposing hinges.

20. The method of claim 17, wherein the energy absorbing element further comprises a connecting member disposed between two adjacent stiff members, wherein the connecting member is disposed nearly perpendicular to the central member.
